(19) United States
(12) Patent Application Publication
(10) Pub. No.: US 2019/0156202 A1
(43) Pub. Date: May 23, 2019

(54) MODEL CONSTRUCTION IN A NEURAL NETWORK FOR OBJECT DETECTION

(71) Applicant: Scopito ApS, Aarhus N (DK)

(72) Inventors: Ken Isobe FALK, Silkeborg (DK); Jeanette B. PEDERSEN, Skanderborg (DK); Henrik LUNDORFF, Silkeborg (DK)

(73) Assignee: Scopito ApS, Aarhus N (DK)

(21) Appl. No.: 16/097,400

(22) PCT Filed: Apr. 25, 2017
(86) PCT No.: PCT/DK2017/050121

§ 371 Date: Oct. 29, 2018

(30) Foreign Application Priority Data
May 2, 2016 (DK) PA 2016 70284

(51) Int. Cl. G06N 3/08

(52) U.S. Cl. CPC G06N 3/08

(57) ABSTRACT

Exemplary computer-implemented method and system can be provided for constructing a model in a neural network for object detection in an unprocessed image, where the construction can be performed based on at least one image training batch. The exemplary model can be constructed by training one or more collective model variables in the neural network to classify the individual annotated objects as a member of an object class. The exemplary model, e.g., in combination with the set of specifications when implemented in a neural network, can perform object detection in an unprocessed image with probability of the object detection.

### CROSS REFERENCE TO RELATED APPLICATION(S)

This application relates to, and claims the benefit and priority from International Patent Application No. PCTDK2017050121 filed on Apr. 25, 2017 that published as International Patent Publication No. WO 2017/190743 on Nov. 9, 2017, which claims the benefit and priority from Danish Patent Application PA 2016 70284 filed on May 2, 2016, the entire disclosures of which are incorporated herein by reference in their entireties.

### FIELD OF THE DISCLOSURE

The present disclosure relates to an exemplary computer-implemented method and system for constructing otherwise generating a model in a neural network for object detection in an unprocessed image, where the construction may be performed based on at least one image training batch. The exemplary model can be constructed by training one or more collective model variables in the neural network so as to classify the individual annotated objects as a member of an object class. The exemplary model, in combination with the set of specifications when implemented in a neural network, can be provided for an object detection in an unprocessed image with probability of object detection.

### BACKGROUND INFORMATION

Significant potentials of deep learning, neural networks and cloud infrastructure to efficiently perform complex data analysis have become more and more apparent as the amount of data grows and the demand for automated tasks is ever expanding.

Massive research and investments worldwide have been made into machine learning and deep convolution neural networks (CNNs). Large companies and research institutions can utilize state-of-the-art solutions where a single neural network can replace very complex algorithms that previously needed to be developed specifically to each use case.

Commercial machine learning image recognition solutions have started to appear in the market. However, these solutions use pre-trained models that can identify common object types like persons, cars, dogs or buildings. One problem with CNNs is that it is very complex to prepare data and configure the networks for good training results. Furthermore, very powerful PCs and graphics processing units (GPUs) are required.

Today, complex machine learning technology is still performed and accessed by highly skilled persons to construct pre-trained models. For example, a high level of computer science and deep learning competences is required to annotate, train and configure neural networks to detect custom objects with high precision. In general, the pre-trained models only find use within the narrow field of which it is trained.

One of the problems with the prior art methods and systems is that the implementations of pre-trained models today are done on standardized training data. These standardized training data are generally limited in both size and application fields and thus, present a problem in terms of expanding the training to developing pre-trained models for other applications. Attempts have been made, especially by researchers in the field of neural networks, to convert neural networks to new domains, however, they often use too few images, due to the very time consuming task of annotating data.

In general, conventional implementations of pre-trained models may provide a very time consuming task of training and constructing models and there is a need of specialist knowledge. The setup of the neural networks requires a specialist while the data annotation is very time-consuming and may take weeks or longer.

As one example of a machine learning technology, International Patent Publication WO 2016/020391 describes a method for training a classifier. The classifier is used in a method for automated analyzing biological images in the field of histology.

Such method is based on analyzing the image using a biological image analysis device which is programmed to perform a classifier function. The classification is performed by combining an object feature with a context feature associated with the object feature. The object features may include the size, shape and average intensity of all pixels within the object and the context feature is a characteristic of a group of objects or pixels. In histology the presence, extent, size, shape and other morphological appearances of these structures are important indicators for presence or severity of disease which motivates the need for accurate identification of specific objects. Thus, the disclosed method aims at achieving a high level of specificity of the objects.

For implementing this method, SVMs are used. SVMs are supervised learning models with associated learning algorithms/procedures that analyze data and recognize patterns, used for classification and regression analysis. Given a set of training digital images with pixel blobs, each marked for belonging to one of two categories, an SVM training algorithm/procedure builds or otherwise generates a model that assigns new examples into one category or the other, making it a non-probabilistic binary classifier. An SVM model is a representation of the examples as points in space, mapped so that the examples of the separate classes are divided by a clear gap that is as wide as possible. New examples are then mapped into that same space and predicted to belong to a category based on the side of the gap onto which they fall.

The method for training the classifier described in International Patent Publication WO 2016/020391 is based on a three-factor framework where a training set of training digital images are used. The images are analyzed to calculate training context feature values and determine feature values of a particular object feature. The classifier is trained on a single object feature and one or more context features.

During the training phase, the classifier builds a model that inexplicitly specifies the relation between the object feature and one or more of the context features. In one example, a training data set consisting of a total of 210 field of view (FOV) images was used wherein negative tumor cells and lymphocytes were manually annotated as the training data. The training data was input to an untrained linear SVM classifier. The example illustrates that context features have a greater descriptive power than has the object feature alone.

U.S. Patent Publication No. 2014/0254923 describes a computer-implemented method of classifying objects in an image. The method described in this publication does not rely on context features—contrary to the method described in International Patent Publication WO 2016/020391, and instead on individual object detection. Such method uses vector description, in order to take account of the rotation and scaling, and the objects in images are classified by a trained object classification process. However, the object classification process is trained through the use of a known training data set of images with known contents.

Another example where SVMs are used is described in the paper “LSUN: Construction of a large scale image dataset using deep learning with Humans in the Loop” by Fisher Yu et al. which provides a construction of a large-scale image dataset using a method which includes human annotating. The method described in this paper is comparable to active learning. However, this method does not aim at learning a model but aims at using existing pre-trained models to construct a large scale annotated image dataset which can be used to train a model and to verify a trained model. The pre-trained neural network is a commercially available neural network, Alexnet. The pre-trained model comprises pre-trained features which are used for initially grouping the images comprised in the image dataset. In the later steps the object classification and the boundaries defining the object classification and the distinction of or gap between the classifications are refined. The human annotating on a number of images is used for training various SVM-models for achieving an amplification of the preliminary human effort of annotating and thus the refinement of the classification.

To exploit the huge potentials of machine learning technology and neural net-works so as to efficiently perform complex data analysis, solutions for simplified procedures are needed. Solutions, which include pre-trained generic models to be used on a wide range of structures and infrastructure inspections, solutions, which allow for non-technical people to train models in CNN's and to use these constructed models to analyze their data, and solutions, which leverage the strengths of cloud infrastructure and CNNs to create a single scalable solution which can work in many different inspection domains.

At the same time image recording have become easy at an unprecedented scale and quality. The recording or collection may also be performed by unmanned airborne vehicles such as drones. Collections of images from a drone inspection include a vast or big amount of data and have shown to introduce accuracy issues when training for or applying neural networks to image recognition.

### OBJECT(S) OF EXEMPLARY EMBODIMENTS

One of the objects of the present disclosure is to overcome one or more of shortcomings of the prior art described herein above.

### SUMMARY OF EXEMPLARY EMBODIMENTS

Such exemplary object of the present disclosure may be achieved with a computer-implemented method and system configured to construct a model in a neural network for object detection in an unprocessed image, where the construction may be performed based on at least one image training batch. The exemplary method and system can implement procedures comprising, e.g., (i) providing a neural network configured with a set of specifications, (ii) establishing at least one image training batch, whereas the batch can comprise at least one training image comprising one or more objects where an individual object is a member of an object class, and (iii) providing a graphical user interface (GUI) configured for displaying a training image from the image training batch. Further, with the exemplary method and system, it is possible to iteratively perform one or more of the following procedures:
annotating object(s) in the training image by user interaction generating individually annotated object(s),
associating an annotation with an object class for the annotated object in the training image by user interaction,
returning a user annotated image training dataset comprising the training image with annotated object(s), each individual annotated object associated with an object class, and/or
constructing a model by training one or more collective model variables in the neural network to classify the individual annotated object(s) as a member of an object class.

The exemplary model, in combination with the set of specifications when implemented in a neural network, can be used for object detection in an unprocessed image with probability of object detection.

The exemplary neural network may be or can include a convolutional neural network (CNN), regional neural network (R-NN), regional convolutional neural network (R-CNN), fast R-CNN, fully segmented CNN and/or any similar structure. The exemplary neural network can be implemented in different frameworks, as examples, but not limited to these, may be mentioned commercial frameworks such as, e.g., Tensorflow, Theano, Caffe, or Torch.

The exemplary specifications of the neural network can, for example, include specification on data types, learning rate, step size, number of iterations, momentum, number and structures of layers, layer configurations such as activation functions (e.g., relu, sigmoid, tank), pooling, number of convolutional layers, size of convolutional filters, number of fully connected layers, size of fully connected layers, number of outputs (output classes), and classification functions. Furthermore, the exemplary specifications may include information on the depth of the network, and structures for the set-up of the neural network. The neural network may be configured with different or additional specifications and thus is certainly not limited to the described examples. The wide range of exemplary specifications may often be reused and many neural networks are already configured with a set of specifications, as examples, may be mentioned commercially available Alexnet or VGG, which specify a range of the above-mentioned specifications. A person skilled in the art would certainly understand how to utilize already established neural networks configured with a set of specifications, adapt or set-up the specifications of already established neural networks or may even set-up a neural network with a set of exemplary specifications.

Image may refer to any multi-dimensional representation of data points recorded by a sensor, orthomosaics or other multi-dimensional representation of data points. This can, for example, include radar images, scanning images from an electron microscope or a MR-scanner, optical images, thermal images, point cloud, acoustic data recording, or seismic recordings. This is just a few examples of images and thus the scope of the present disclosure is in no way limited to the described examples.

The iteratively performed exemplary procedures/acts can be performed, in one example, only if the image provides for the specific procedure/act. In case the image training batch comprises a blank training image or a training image comprising no relevant objects to be annotated, the act(s)/procedure(s) related to annotating an object may be omitted.

An exemplary object detection in an image can comprise both object recognition and localization of the object. Object exemplary recognition(s) may also be perceived as object classification.

The exemplary object detection may for example be used for mapping or surveying infrastructure where object detection may be actual image objects, temperature changes in thermal images, or specific frequency scales on acoustic images. The exemplary object detection can, for example, comprise common occurring objects, rarely occurring objects or a combination. Such example are only a limited number of examples which are not meant to be in any way limiting, and the scope of the present disclosure is by no means limited to such examples.

Probability of an exemplary object detection refers to the possibility of the object detection on an image by the network and the possibility of that object belonging to an object class, whereas accuracy refers to how accurate the network actually is when determining an object and object class where the predictions of the network are tested on an image verification batch.

In one exemplary embodiment of the accuracy of the exemplary object detection can describe the circumstance that the user sets a threshold in the program. If the marked object is above this threshold, the neural network can suggest this object class to be associated with the marked object.

One exemplary effect of the exemplary embodiment of the present disclosure can be that the data used for training the collective model variables in the neural network, for construction models to classify the individual annotated objects as a member of an object class, in one example, can only comprises a training image data batch, annotation of relevant objects, and associated object classes. Thus, the provided data preparation would not require a high level of computer science and deep learning competences, which can have the advantage that the training may be performed by non-skilled persons within computer science and deep learning. The persons performing the training only would use (or need) the skills of recognizing relevant objects on the images.

Another exemplary effect of the exemplary embodiment of the present disclosure can be that the training may be performed on a wide range of objects with the advantage that collective model variables may be trained for constructing models for a wide range of object detection. Thus, this exemplary embodiment can be advantageous in regard to constructing models for the exemplary object detection to operate in many different inspection domains. Furthermore, regarding constructing models for object detection, it can be beneficial with a high degree of invariance, for example, to specifically outline the objects, size, scale, rotation, color or the like. The invariance may encompass a number of features and is by no means limited to the examples described herein.

Thus, according to the exemplary embodiments of the present disclosure, the training may encompass one or more models for the detection of one or more objects or multiple models, e.g., each model constructed for detection of one or more objects.

Yet another exemplary effect of the exemplary embodiment of the present disclosure can be that the training may be performed for object detection with a given accuracy. One advantage can be that the training may be completed with an accuracy of object detection evaluated to be sufficient for the given task, thereby limiting the training effort and time to a minimum. This may also be advantageous in that the level of training may be accustomed to the complexity of the object detection.

An additional exemplary effect of the exemplary embodiment of the present disclosure can be that the training may be performed using an image training batch, which can comprise training images with multiple objects, where each individual object belongs to different object classes. One exemplary advantage such exemplary effect and the exemplary embodiment may be that multiple models for individual object classes may be constructed in one training process, thereby limiting the training effort and time to a minimum. The multiple models may, for example, be used as one comprehensive model for multiple object detection on a wide range of structures and infrastructure inspections, or a single model may be separated out for more focused object detection on a single structure in very specific infrastructure inspections.

Yet an additional exemplary effect of the exemplary embodiment of the present disclosure can be that the training may be performed by multiple users on either multiple image training batches, or on one image training batch with the advantage of leveraging the strengths of cloud infrastructure and CNNs to construct a model with limited training effort and time consumption for each user.

In case of the exemplary training with several users it may be preferable to incorporate history on the user interactions and appoint different user levels, where the user level is associated with a hierocracy for object annotation and object classification.

The exemplary effect of multiple users may be that the training can be divided into more users. Furthermore, more users may provide for a more diverse image training batch, if each user contributes with different images. Furthermore, a more comprehensive image training batch may be established if more users contribute with their own images. This can be advantageous for a reduced time-consumption for the individual user, improved accuracy of object detection and thus constructing more accurate models.

One exemplary object of the exemplary embodiments of the present disclosure may be achieved by the computer-implemented method and system which can iteratively be used and/or configured to perform certain exemplary acts/procedures. Such exemplary acts/procedures can comprise displaying a training image comprising one or more machine marked objects associated with a machine performed classification of the one or more individual objects, changing the machine object marking, the machine object classification or both, and/or evaluating the level of training of the collective model variables for terminating the training of the model.

In general, e.g., the annotation can be used in relation to an action performed by user interaction through the graphical user interface while marking is used in relation to an action performed by the neural network based on the constructed model.

One exemplary effect of the exemplary embodiment of the present disclosure can be that the collective model variables are continuously trained in the iterative performed acts and that the constructed model is improved accordingly after each performed iteration. This can be advantageous for continuously evaluating the level of training such that the training can be terminated once an appropriate accuracy of object detection is reached, thereby likely limiting training effort and time consumption of excessive training.

The exemplary iterative training may have the further effect that correct performed markings may simply be accepted and thus less and less annotations have to be performed as the training proceeds. As the training proceeds, the annotations can be limited to be performed on images with new information, different viewpoints or objects within the same class but with features not seen on the previous images. The iterative training may therefore present the advantage that the time consumed for training is reduced by factors of time.

Another exemplary effect of the exemplary embodiment of the present disclosure can be that object marking and object classification can be changed to correct the training of the collective model variables. This may be advantageous for continuously adjusting the training.

The exemplary model may also include collective variables for the part or parts of the images not comprising objects, which may be referred to as background. The iterative act of annotating may thus include annotating sections of the background and associating this or these annotations with an applicable object class, for example “background”, “other”, “non-applicable”, “non-object” or other creatively named classes. The annotation of the background may comprise small sections of the image background, a complete image or the remaining part of the image surrounding other annotated objects. The effect of annotating sections comprising background and classifying this is to establish segregation between background and other objects, the relevant objects to be detected. It is important to obtain a broad diversity in the annotated sections of background to improve the accuracy of segregation between background and other objects and thus the probability and accuracy of object detection.

Based on performed experiments, certain beneficial results can be obtained by annotating small sections of the image background in combination with annotating complete images without any relevant objects. Further, the described methods and systems, alone or in combination, may be applicable with appropriate and acceptable results.

Another exemplary object of the present disclosure may be achieved by the computer-implemented method and system, whereas the exemplary acts/procedures of annotating, associating and/or returning can be performed iteratively before subsequently performing the exemplary act/procedure of constructing.

Another exemplary effect of the exemplary embodiment of the present disclosure can be that the user interaction may be performed on a sub-batch of training images without waiting for the act of construction to be per-formed between each image. By postponing the exemplary acts/procedures of construction and collecting the act of constructing for the entire sub-batch, the user may earn the advantages of a concentrated work effort on the sub-batch and consecutive time for performing other tasks while the act of constructing is performed.

A further exemplary object of the present disclosure may be achieved by the computer-implemented method and system which can be configured or caused to perform an intelligent augmentation.

Data augmentation is the procedure of changing the image of an object without changing the object class, regardless of localization in the image. This can mean that the object is the same object no matter if the object is lighter or darker than before, if it is rotated or not, whether it is flipped or not, to mention a few non-limiting examples. Common practice, e.g., to reduce the number of training data used or needed for training one or more collective model variables in the neural network is to adapt the present image training set to simulate different images. This can mean that one image of an object may be expanded to multiple images of the same object but imaged with different variations—the number of new images may be as many as 500 or more. With the use of the intelligent augmentation, it is possible that only the relevant changes to an image of an object are considered. Thus, one of the purposes of the exemplary intelligent augmentation can be to use the data augmentation in an intelligent way to reduce the complexity of the neural network. For example, if a rotation of an imaged object never occurs in real images, it may take up complexity in the neural network and may rarely or never be used. This can mean that some weights would be reserved for this information, e.g., and thereby cannot be used for something else that might be more relevant, which may cost some accuracy.

Thus, the exemplary intelligent augmentation implemented and included in this exemplary embodiment of the present disclosure can provide for processing of the image for a better accuracy of the object detection. This exemplary processing may include, e.g., scaling of the images, rotation of the images based on annotations and associating annotations and object classes. The annotation may be performed on objects of different sizes or displayed in different angles, which is exactly what may be used in intelligent augmentation for more accurate object detection.

One exemplary object of the present disclosure may be achieved by the computer-implemented method and system which can be used, configured and/or programmed to establish at least one image verification batch.

Establishing such one or more image verification batches may have the effect of evaluating the accuracy of the constructed model. The image verification batch is, in one example, not used for training but only to test the constructed model. This may be advantageous in comparing a previous reached training level with a subsequent model constructed after further training.

Furthermore, from the verification batch and the accuracy by which the object detection is performed, the accuracy may be used in itself to establish if the model has the sufficient accuracy. Thereby, it is possible to evaluate whether the model should be changed, more training data should be provided, or the accuracy may be reached using a simpler model. The advantage of using for example a simpler model is that less memory is required, and thus less disk space and less training data may be needed.

A further exemplary object of the present disclosure may be achieved by the computer-implemented method and system which can be used, configured and/or programmed to evaluate the constructed model or the use of the neural network specifications for, e.g., reducing complexity of the model, reducing the specifications, or both.

An exemplary effect of this exemplary embodiment of the present disclosure can be that a simpler model or a simpler neural network may be used for training the collective model variables. This may be advantageous to reduced processing time. Another advantage may be that the required PC capacity may be reduced. Yet another advantage may be that less powerful graphic processing units (GPUs) may be used. This initiates using cheaper hardware elements and thus reduces costs for training or object recognition, or both.

As described herein, the advantage of using for example a simpler model is that less memory is required, and thus less disk space and less training data may be required.

Still another object of the present disclosure may be achieved by the computer-implemented method and system which can be used, configured and/or programmed to evaluate the accuracy of object detection for reducing the image training batch.

The exemplary effect of reducing the image training batch is that the training effort and time spent by the user may be reduced resulting in reduced costs for training.

In another exemplary aspect the image training batch may be reduced by omitting cluttered, shaken or blurred images. Including these images may harm the training with reduced accuracy as a result. Alternatively or in addition, the relevant objects in such images may be pruned and thus still be used in the image training batch, which may have the advantage of widening the object recognition and thus increasing the accuracy of object detection.

One additional exemplary object of the present disclosure may be achieved by the computer-implemented method and system, using which, annotating an object can be performed by an area-selection of the training image comprising the object or pixel-segmentation of the object.

One exemplary effect of this exemplary embodiment can be that common practice of annotating objects may be used with the advantage of facilitating that the computer-implemented method may be implemented on a wide range of neural networks.

A further exemplary object of the present disclosure may be achieved by the computer-implemented method, using which annotating an object can be performed using a computer-implemented annotation tool configured with a zoom-function. The computer-implemented annotation tool can be configured for providing an area-selection interface for area-selection of an object in the training image by user interaction, which area-selection is adjustable, configured for providing a pixel-segmentation interface for pixel-segmentation of an object in the training image by user interaction, which pixel-segmentation is configured to pre-segment pixels by grouping pixels similar to a small selection of pixels chosen by user interaction, or configured for both. Furthermore, the annotation tool is configured to transform annotation from pixel-segmentation of an object into area-selection of the object in the training image.

The zoom-function can have the effect that more precise annotations may be performed comprising a minimum of background with the advantage of accurate object detection.

The adjustable area-selection can provide for the same or similar effect and advantage as the zoom-function.

Another exemplary effect of the fact that the pixel-segmentation of this exemplary embodiment can be configured to pre-segment pixels is that only a small selection of pixels may be chosen by user interaction, after which the computer-implemented annotation tool pre-segments pixels by grouping pixels similar to the small selection of pixels chosen by user interaction. Thus, each pixel comprised in the object does not have to be selected by the user which may be a tedious and imprecise process.

Another exemplary effect of such exemplary embodiment, as the annotation tool is configured to transform annotation from pixel-segmentation of an object into area-selection of the object in the training image is, that the annotation may be saved to other formats of neural networks and may thus be used independent of the format or type of the neural networks.

A further exemplary object of the present disclosure may be achieved by the computer-implemented method and system, whereas the computer-implemented annotation tool further provides for color overlay annotation, which color is associated with an object classification and which object classification is associated with the annotation, provides for re-classification of one or more individual annotated objects, machine marked objects or a combination of both, or provides for both. Furthermore, the annotation tool can be configured to show all annotations and machine marks associated with an object class in one or more training images.

One exemplary effect of this exemplary embodiment is that the associated classes are easily identified due to the color overlay. Typically there will be several types of object classes on the same image which is especially advantageous to easily identify the different associated class and thereby identify erroneously annotations or classifications. The embodiment has the further effect that erroneously annotations or classifications may be corrected immediately.

Another exemplary effect of this exemplary embodiment is that when all annotation, marking and associated object classes are shown, it provides for easy correction of mistakes with the advantage of optimizing the training.

The exemplary computer-implemented method and system according to an exemplary embodiment of the present can be provided, whereas the computer-implemented annotation tool further provides for history of the performed annotation.

In case of training with several users this exemplary embodiment may have the effect that annotations performed by super-users may not be overwritten by less experienced users, which may be advantageous in regard to achieving a high level of training. A further exemplary effect can be that the user may see his/her own annotation history which may be advantageous in regard to improving his/her own skills.

Another exemplary effect of this may be that the history comprises relevant information on whether an object is originally annotated by a human or if it is originally marked by the neural network. Even if the annotation or marking is accepted, there may be issues with the precision of edges. The user might be inclined to accept an imprecise but correct result from the neural network compared to if the user had to make the annotation. This may present inaccuracies in the training if not corrected. Thus, for an experienced user this may be discovered when consulting the history on the annotations/markings and be corrected to restore or improve the accuracy in the training.

In one exemplary aspect, the computer-implemented annotation tool may comprise a function to rotate a marking or an annotation. Rotated marking or an annotation provides for selecting objects that are inclined, without getting too much background. Thereby, achieving markings/annotations with a better fit for selection so that the training can be more precise according to such exemplary embodiment.

In another exemplary aspect, the computer-implemented annotation tool may comprise a function to move an area-selection to a new object, and thereby avoid redrawing the annotation box if the new object has the same properties.

In yet another exemplary aspect, the computer-implemented annotation tool may comprise a function to repeat an area-selection. If multiple objects appear in an image, this function can repeat the area-selection to the next object, thereby avoiding redrawing the annotation box if the next object has the same properties.

In yet another exemplary aspect, the computer-implemented annotation tool may comprise a one-key-function for saving the image including annotation and object classes and which function provides unique identifiers for the image dataset to be saved. Thereby overwriting existing data is avoided and time consumption can be reduced. Furthermore, the user does not have to remember the sequence of names as the function may keep track of these.

The exemplary computer-implemented method and system according to an exemplary embodiment of the present can be provided, whereas the navigation in the image training batch can be performed using a computer-implemented navigation tool providing for navigation by image management, and providing for status on progression of evaluating the image training hatch.

One exemplary effect of this exemplary embodiment may be that the user may be motivated by following the progress, with the advantage of keeping the user alert, and thereby avoid erroneously annotations or wrong object classes associated with the annotations.

Another exemplary effect may be that the user may gain a better overview of the image training batch and may skim through the training images, thereby only focusing on images with relevant objects. This may have the advantage of keeping the user alert to avoid mistakes and furthermore limit the training effort and time consumption provided by the user for the training.

The exemplary computer-implemented method and system according to an exemplary embodiment of the present can be provided in a neural network for object detection in an unprocessed image with probability of object detection. The exemplary method and system can implement acts/procedures which comprise, e.g., providing a constructed model to a neural network configured with a set of specifications, establishing at least one unprocessed image batch, which batch comprises at least one unprocessed image to be subject for object detection, an act of providing a graphical user interface (GUI) configured for displaying one or more unprocessed images with a set of marked objects, each individual marked object associated with an object class, performing object detection in an unprocessed image, and returning the unprocessed image with a set of marked objects, each individual marked object associated with an object class.

One exemplary effect of this exemplary embodiment can be that the huge potential of machine learning technology and neural networks to efficiently perform complex data analysis may be utilized by non-skilled persons within computer science. This can be advantageous in regard to allowing non-skilled persons within computer science to use constructed models in neural networks to analyze their data which may provide of reduced time and cost. The reduction in cost and time may be both in regard to hardware requirements and in labor.

The exemplary computer-implemented method and system according to an exemplary embodiment of the present can be provided in a neural network for object detection, whereas access to a neural network for further training one or more collective model variables of the model can be provided, such that the model is subject to improved accuracy of object detection.

One exemplary effect of this exemplary embodiment can be that the model may be continuously improved or updated. This can be advantageous if objects with new features appear on the market which objects belong to an already existing object class. In this case the model may be trained to include this object without training a new model.

### Examples of User Cases:

### Case 1:

A user has made an inspection resulting in 1000 images and would like to set up a new model to detect one class of objects, in this case insulators. Thus, the image training set comprises 1000 images.

The user selects an existing neural network comprising a set of specifications. The user then specifies the relevant number of object classes, in this case two classes: insulators and background. Furthermore, the user specifies that annotation is performed by pixel-segmentation.

The user then looks through the first 10 training images and chooses a small selection of pixels where after the annotation-tool through pre-segmenting pixels in the image performs the complete pixel-segmentation.

After annotation of the first 10 images the first process of training the collective model variables is performed and a model is constructed. The model is then able to provide suggested markings for the remaining 990 images.

The user looks through the next 40 images. On 30 images the objects are marked correctly and thus, the user accepts these without changing the markings or the classifications. On 10 images the objects are not marked correctly so these are corrected.

A second process of training the collective model variables is performed and an updated model, is constructed. The model is improved by the second process and with an improved accuracy of object detection.

As the model is improved the user now looks through the next 100 images. This time only 10 of the images comprise incorrect markings. The markings on the other 90 images are correct and accepted.

Accepting an image is a one button click, and the program automatically proceeds to the next image. As the user reaches image no. 500 this image and the next 100 images do not comprise any relevant objects (insulators) for this case. The user goes to navigation thumbnail view where the current image is highlighted and scrolls through the next 100 images down to image no. 600—the next image whereon insulators again appear. The user then chooses this picture through the user interface by clicking on that image, after which the user continues accepting or correcting markings.

In between, the user may optionally stop to train the model so the markings get iteratively better. The user may stop after completing the 1000 images an updated model is constructed—for this case the “first version” model.

Before continuing, the user initiates a new training on the same 1000 images starting with the constructed “first version” model. This time, the training is done with a higher number of iterations. This extends the training time but is done to improve the accuracy of the model. After completing the 1000 images, the further updated model is constructed—for this case the “second version” model.

A second user is also interested in insulators but wants to distinguish between glass insulators and ceramic insulators. The user therefore specifies two new classes: “Insulator, glass” and “Insulator, ceramic”.

The second user benefits from the fact that a large image training hatch has already been used to construct a model for object detection on insulators. The second user then loads the previously annotated training set and in the thumbnail view the user can now see all markings of insulators. For each insulator the second user can now, through the user interface, simply click on each marking and change the object class to any of the two newly specified classes. The second user does not have to do the marking again, and furthermore does not have to look through the images without insulators. The second user may now finish the training by constructing the new up-dated model—for this case the “third version” model.

A third user wants to know if an insulator is comprised in an unprocessed image batch or not. This user is not interested in knowing exactly which pixels image the insulator contains. This user specifies that area-selection shall be used. This user—just as the second user—benefits from the fact that a large image training batch has already been used to construct a “first version” model for object detection on insulators. Furthermore this user—again just as the second user—now loads the previously annotated training set and the neural network converts the pixel-segmented insulators to area-selected insulators using intelligent data augmentation for this type of neural network. The third user may now finish the training by constructing yet another new updated model—for this case the “fourth version” model.

An objective may be achieved by use of a computer-implemented method for constructing a model in a neural network as outlined and where images are collected by use of by use of an airborne vehicle such as a drone.

In particular unmanned airborne vehicles such as drones may be used for inspection of areas or infrastructure. Drones have proven a valuable tool carrying image recording devices to places not hereto accessible. Likewise drones have proven capable of positioning image recording devices in a breath of angles, distances etc. of subjects. Furthermore, drones have proven capable of tracking paths of structures or infrastructure and of being capable of collecting vast amounts of images during operation.

In practice, drone operators and inspectors would aim to collect as many images as possible during a flight that is often planned in detail and must be performed taking limited flight time into account.

Thus, an image batch from a drone flight comprises a vast amount of images often from different—or slightly different—angles of a subject or often similar subjects from different locations along a flight path. Another problem with such series or col-lection of images is that the drone inspection result in images taken from a perspective hereto un-seen by human inspection.

With the exemplary methods and systems according to the exemplary embodiments of the present disclosure, issues with training or construction of models can be overcome, and management of the big data collected can be facilitated.

Likewise, exemplary computer-implemented method and system in a neural network for object detection can be used, whereas an unprocessed image or a batch of images is obtained from a drone flight has shown to be more accurate than hereto.

### Further Aspects to Case 1:

The users may choose that 20% of the images are reserved for an image verification batch and thus, the remaining 80% of the images comprise the image training batch. The image verification batch may be used to test the accuracy of the constructed model.

Through the training of the collective model variables and as the intermediate models are constructed, the accuracy of an intermediate model may be tested by use of the verification batch. Thereby the accuracy of the model may be made available to the user. Furthermore, the neural network may suggest whether the model should be further improved or if simplifications may be done to the training.

As a further training of both the “third version” and the “fourth version” model the respective second and third user may add and annotate new images with imaged insulators. These imaged insulators could be previously known insulators or a new class unknown to the system.

### Case 2:

A user loads a satellite image map of Greenland. The user marks polar bears x number of times. The system can now detect polar bear locations and the total number of polar bears.

### Case 3:

A user adds one or more thermal images of central heating pipes for a given area. The user specifies 5 classes each representing the severity of a leak. After marking these classes the system can now identify leaks with a 1-5 severity degree. In this case the present disclosure is used for object detection of objects where the object classes consist of fault classes.

### Case 4:

Whenever the training of the collective model variables is completed and thus, a constructed model is completed, the neural network evaluates if the completed model should be made available to other users. The evaluation criteria could for example be user ranking, model accuracy, and the number of images in the verification batch, hence the number of images which are used to determine the accuracy.

The aspects described above and further aspects, features and advantages of the present disclosure may also be found in the exemplary embodiments which are described in the following with reference to the appended drawings and claims.

### BRIEF DESCRIPTION OF THE DRAWINGS

Further exemplary embodiments of the present disclosure are detailed in the description of the Figures, where this description shall not limit the scope of the present disclosure. The Figures show the following:

FIG. 1 is a flow diagram of a computer-implemented method for constructing a model in a neural network for an object detection in an unprocessed image according to an exemplary embodiment of the present disclosure;

FIG. 2 is a flow diagram of the computer-implemented method for constructing the model in the neural network for the object detection in the unprocessed image according to another exemplary embodiment of the present disclosure;

FIG. 3 is a flow diagram of the computer-implemented method for constructing the model in the neural network for the object detection in the unprocessed image according to yet another exemplary embodiment of the present disclosure;

FIG. 4 is a flow diagram of the computer-implemented method for constructing the model in the neural network for the object detection in the unprocessed image according to still another exemplary embodiment of the present disclosure;

FIG. 5 is a flow diagram of the computer-implemented method for constructing the model in the neural network for the object detection in the unprocessed image according to a further exemplary embodiment of the present disclosure;

FIG. 6 is an exemplary training image;

FIG. 7A is a diagram of an area-segmentation (7A) according to an exemplary embodiments of the present disclosure;

FIGS. 7B and 7C are diagrams of an pixel-segmentation (7A) according to an exemplary embodiments of the present disclosure;

FIGS. 8A and 8B are diagrams of a computer-implemented annotation tool according to an exemplary embodiment of the present disclosure;

FIGS. 9A and 9B are diagrams of an intelligent data augmentation according to an exemplary embodiment of the present disclosure;

FIG. 10 is a block diagram of a computer-implemented navigation tool according to an exemplary embodiment of the present disclosure; and

FIG. 11 is a flow diagram of a computer-implemented method for constructing the model in the neural network for the object detection in an unprocessed image according to a still further exemplary embodiment of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure as defined by the appended claims.

### DETAILED DESCRIPTION OF THE PRESENT DISCLOSURE

### Exemplary List of Reference Signs

| No. | Item |
|---|---|
| 10 | Neural network |
| 12 | Specifications |
| 14 | Collective model variables |
| 16 | Trained collective model variables |
| 18 | Image dataset |
| 20 | Model |
| 22 | Machine-mark |
| 24 | Annotation |
| 26 | Pixel-segmentation |
| 28 | Area-selection |
| 30 | Navigation |
| 40 | Object detection |
| 42 | Probability |
| 43 | Accuracy |
| 50 | Unprocessed image |
| 52 | Unprocessed image batch |
| 60 | Image training batch |
| 62 | User annotated image training dataset |
| 66 | Training image |
| 68 | Image verification batch |
| 70 | Object |
| 72 | User annotated object |
| 74 | Machine marked object |
| 80 | Graphical user interface (GUI) |
| 82 | User interaction |
| 90 | Object class |
| 92 | User classified object |
| 94 | Machine classified object |
| 96 | Re-classification |
| 100 | Computer-implemented method for constructing |
| 102 | Constructing |
| 104 | Providing |
| 106 | Establishing |
| 108 | Performing |
| 110 | Annotating |
| 112 | Associating |
| 114 | Returning |
| 116 | Training |
| 118 | Classifying |
| 120 | Displaying |
| 122 | Marking |
| 124 | Evaluating |
| 126 | Terminating |
| 128 | Reducing |
| 130 | Changing |
| 140 | Intelligent augmentation |
| 160 | Computer-implemented annotation tool |
| 162 | Zoom-function |
| 164 | Area-selection interface |
| 166 | Adjustable |
| 168 | Pixel-segmentation interface |
| 170 | Pre-segment |
| 172 | Pixel |
| 174 | Colour overlay annotation |
| 180 | History |
| 190 | Computer-implemented navigation tool |
| 192 | Image management |
| 194 | Status |
| 196 | Progression |
| 200 | Computer-implemented method for object detection |

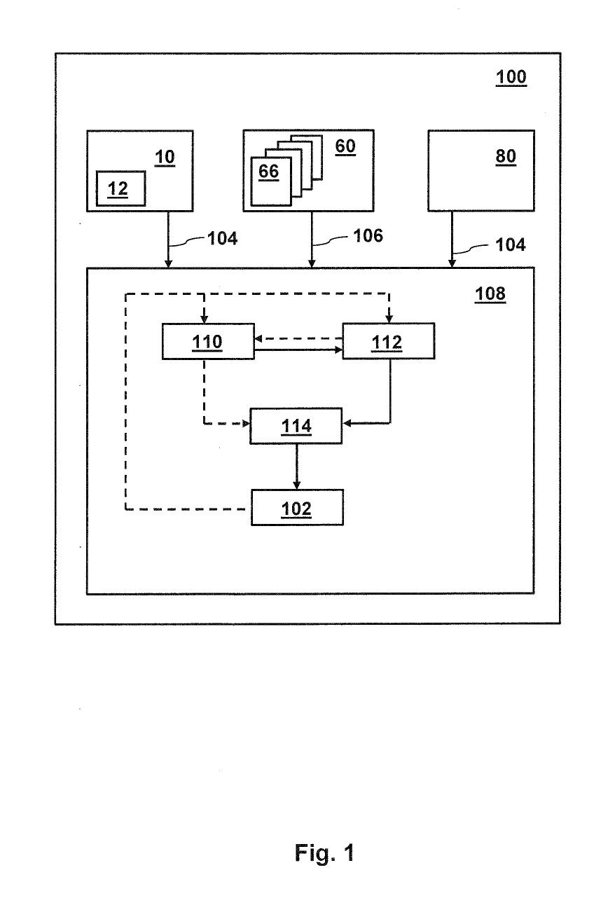

FIG. 1 illustrates a flow diagram of an exemplary embodiment of the computer-implemented method (100) for constructing (102) a model (20) in a neural network (10) for object detection (40) in an unprocessed image (50), according to the present disclosure. The exemplary method comprises the acts/procedures of, e.g., providing (104) a neural network (10) and a GUI (80). Furthermore, an image training batch (60) comprising training images (60) is established (106) in this embodiment. The neural network (10) is configured with a set of specifications (12). These specifications may comprise, amongst other, information on number of layers and collective model variables. The GUI (80) may be configured for displaying a training image (66) and for displaying user interactions (82) such as annotated objects and object classes.

The exemplary computer-implemented method (100) shown in FIG. 1 further comprises acts/procedures which may be iteratively performed (108). These acts/procedures can include annotating (110) objects (70) on the training images (66) and associating (112) each annotation with an object class (90). The acts/procedures of annotating (110) and associating (112) may be performed in any order, such that an object may be annotated after which an object class is associated with the object annotation, or an object may be associated with an object class after which the object is annotated. The iteratively performed acts/procedures further illustrated in FIG. 1 can include returning (114) a user annotated image training dataset, which training dataset comprises the training image and annotated object with an associated object class if relevant objects are present on the image, and constructing (102) one or more models.

The broken lines illustrate that the acts/procedures of annotation (110) and associating (112) may be interchanged, as already described. Furthermore, the broken line illustrates that the acts may be performed in an iterative process, where the model construction receives additional input for each performed iteration. The exemplary method of this exemplary embodiment may comprise, e.g., only a single iteration of acts/procedures, and thus each act may only be performed once. Furthermore, each iteration may only comprise some of the acts/procedures. For example, if no relevant objects are present on the image, act/procedure of annotating (110) and associating (112) of object class would not be performed.

After completing the image training batch (60), a trained model (20) can be constructed (102).

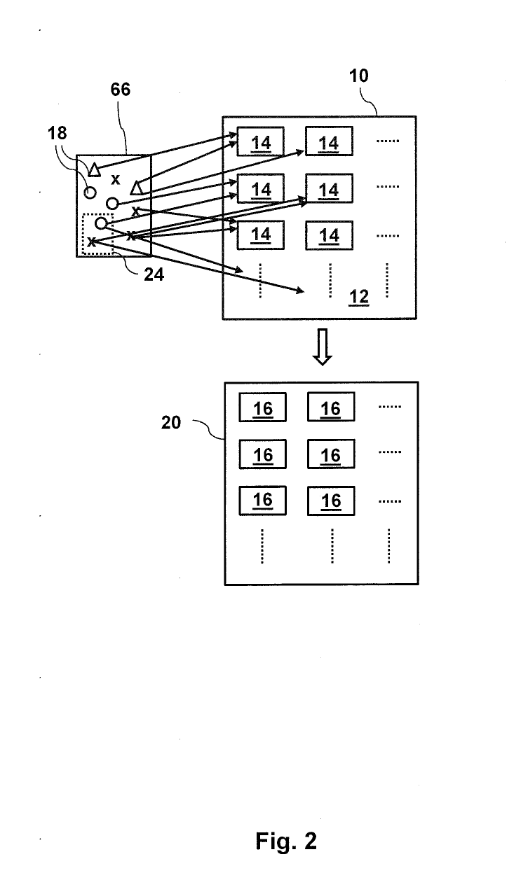

FIG. 2 illustrates a flow diagram of another exemplary embodiment of constructing a model (20) in a neural network (10) for object detection in an unprocessed image. A training image (66) may be de-scribed in an image dataset (18), here illustrated by triangles, crosses and circles. The image dataset is interpreted by the collective model variables in the neural network (10). The training image (66) may comprise an annotation (24) and thus part of the image dataset may be interpreted as annotated data. The constructed model (20) can comprise the trained collective model variables (16) resulting from the process of interpreting image datasets by the collective model variables (14) in the neural network (10).

The constructed model (20) can further comprise the set of specifications (12) with which the neural network (10) is configured.

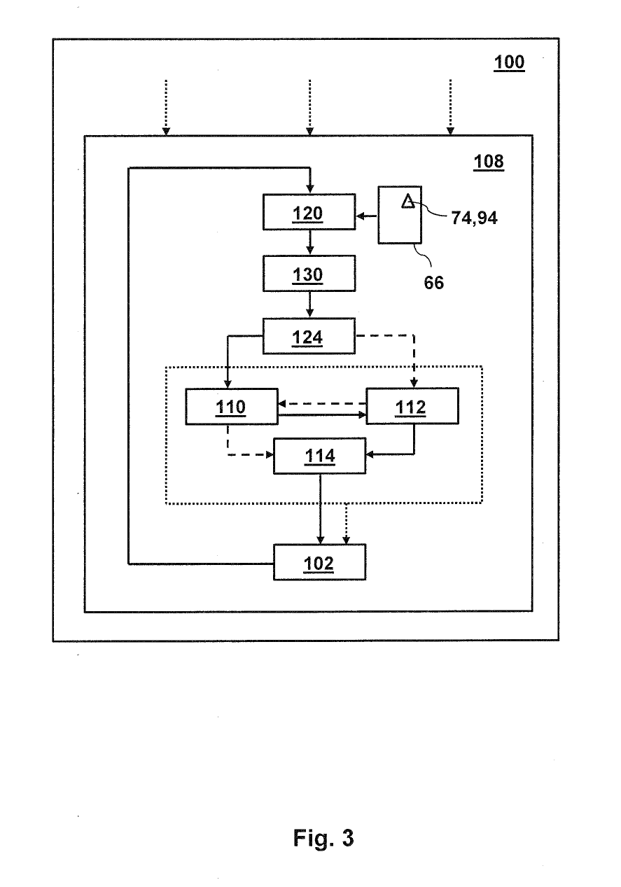

FIG. 3 illustrates a flow diagram of yet another exemplary embodiment of a computer-implemented method (100) for constructing (102) a model (20) in a neural network (10) for object detection in an unprocessed image. The exemplary method shown in FIG. 3 can comprises a method illustrated in FIG. 1, with additional acts. The dotted lines refer to acts/procedures previously described above and shown in FIG. 1. This exemplary method of FIG. 3 illustrates the further acts/procedures which may be performed after a model is constructed (102), and therefore the dotted arrow pointing to the act of constructing (102) a model is where the iterative performed acts continue from the acts/procedures illustrated in FIG. 1.

The exemplary model can be constructed on basis of a single training image (66). Thus, when the exemplary model is constructed (102), the computer-implemented method (100) may comprise the following described acts/procedures which may be iteratively performed along with the iteratively performed acts/procedures shown in FIG. 1 of annotating (110), associating (112) and returning (114).

These exemplary acts/procedures may comprise displaying a training image (66) from the image training batch (60), which training image may comprise a machine marked object (74) and the associated object classification (94) performed using the constructed model. If the machine marking or classification or both are incorrect, this may have to be corrected and thus, an act/procedure of changing (130) the object marking, classification, or both may be performed by user interaction. If no changing (130) is performed, the act/procedure of evaluating (124) the level of training would be performed. If no changes (130) are performed and furthermore no relevant objects are found to be unmarked, unclassified or both the level of training may be evaluated (124) as sufficient and the training may be terminated with the constructed model (102) as a result.

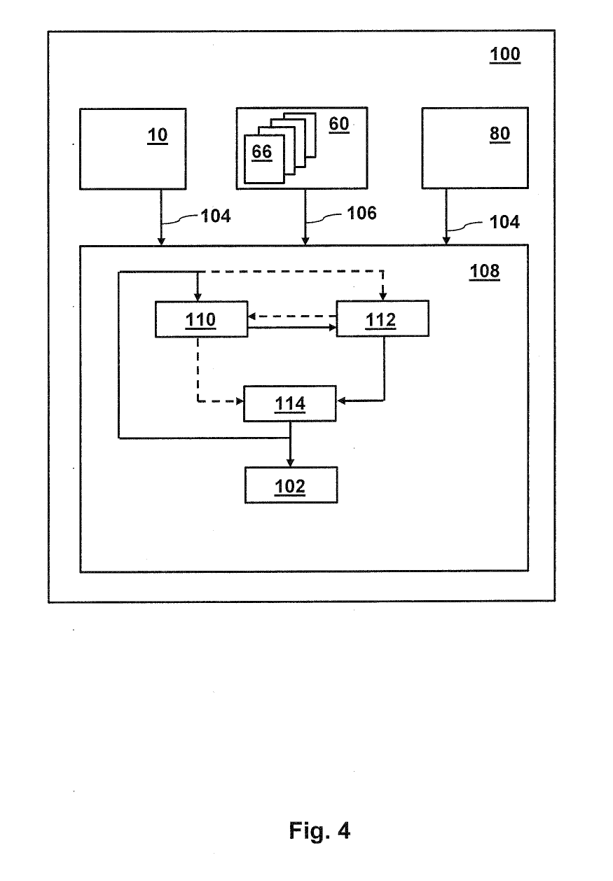

FIG. 4 illustrates a flow diagram of yet another exemplary embodiment of the computer-implemented method (100) for constructing (102) a model (20) in a neural network (10) for object detection (40) in an unprocessed image (50).

Similar to the exemplary embodiment of the method illustrated in FIG. 1, the method shown in FIG. 4 comprises the acts/procedures of providing (104) a neural network (10) and a GUI (80). Furthermore, an image training batch (60) comprising training images (60) is established in this exemplary embodiment. The neural network (10) can be configured with a set of specifications (12). These specifications may comprise, amongst other, information on number of layers and collective model variables. The GUI (80) may be configured for displaying a training image (66) and user interactions (82), such as, e.g., annotated objects and object classes.

The computer-implemented method (100) illustrated in FIG. 4 can further comprise acts/procedures which may be iteratively performed (108). These exemplary acts/procedures can include annotating (110) objects (70) on the training images (66) and associating (112) each annotation with an object class (90). The exemplary acts/procedures of annotating (110) and associating (112) may be performed in any order, such that an object may be annotated after which an object class is associated with the object annotation, or an object may be associated with an object class after which the object is annotated. The iteratively performed acts/procedures can further include returning (114) a user annotated image training dataset, which training dataset comprises the training image and annotated object with associated object classes if relevant objects are present on the image.

The method of this exemplary embodiment can differ from the method of the exemplary embodiment shown in FIG. 1 as the acts/procedures of annotating (110), associating (112) and returning (114) can be performed (108) iteratively before subsequently performing (108) the act/procedure of constructing (102).

An alternative exemplary embodiment of the method may comprise that two iterative processes are performed. An inner iterative process comprising the acts/procedures of annotating (110), associating (112) and returning (114) may be performed (108) iteratively before subsequently performing (108) an outer iterative process wherein the further act/procedure of constructing (102) can be performed.

The broken lines illustrate that the exemplary acts/procedures of annotation (110) and associating (112) may be interchanged, as already described. Furthermore, the broken line illustrates that the acts may be performed in an iterative process, where the model construction receives additional input for each performed iteration. In an exemplary embodiment, only a single iteration of acts/procedures can be performed, and thus each act/procedure may only be performed once. Furthermore, e.g., each iteration may only comprise some of the acts/procedures. For example, if no relevant objects are present on the image, no act of annotating (110) and associating (112) of object class would be performed.

After completing the image training batch (60), a trained model (20) can be constructed (102).

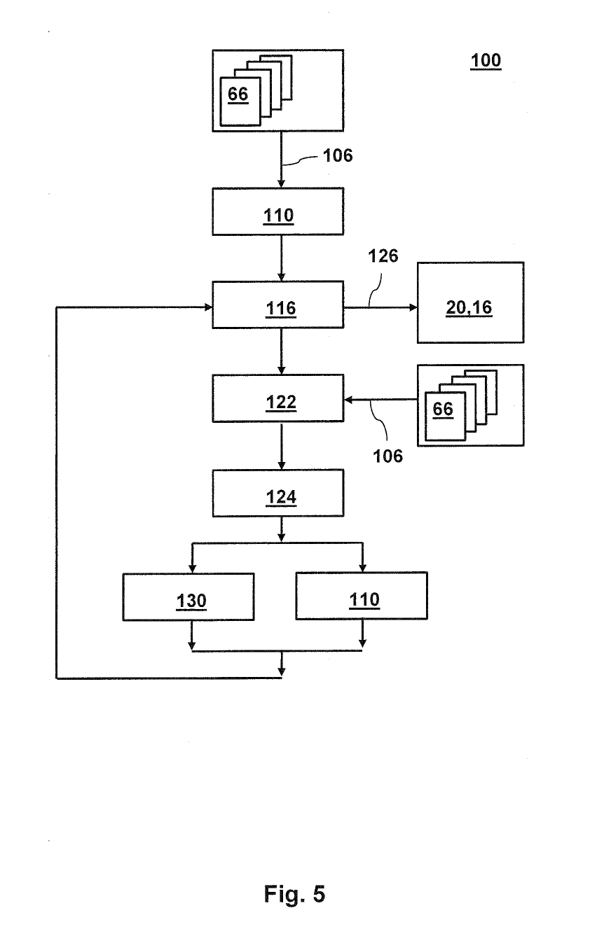

FIG. 5 illustrates a flow diagram of a further exemplary embodiment of a computer-implemented method (100) for constructing a model (20) in a neural network for object detection in an unprocessed image. The exemplary method comprises the acts/procedures of providing (104) a neural network (10) and a GUI (80) not illustrated. Furthermore, an image training batch (60) comprising training images (60) is established (106) in this exemplary embodiment. For example, annotating (110) of objects can be performed in a first sub-batch of the image training batch (60). Based on the annotated images, the collective model variables can be trained (116) in the neural network for constructing a model (20). Subsequently a second sub-batch of the remaining image training batch can be established (106) and the constructed model is used for marking (122) objects in the second sub-batch. After the machine performed marking (122) these markings are evaluated (124) by user interaction. This evaluation of the second sub-batch may lead to changing (130) of the machine marking, additional annotation (110) of objects or both. Depending on whether the evaluation (124) of the machine marking gives reasons for changing (130) object markings or annotating (110) additional objects, the collective model variables can be further trained (116) either by confirming that the object marking (122) is correct or by performed changes and/or additional annotations.

If the exemplary model is evaluated to be trained further, a third sub-batch of images may be established and another iteration, starting with marking (122) objects using the updated constructed model, may be performed.

If the collective model variables are evaluated as being sufficiently trained, the exemplary method can be terminated (126), and the trained collective model variables (16) can comprise the constructed model (20) for subsequent use in a neural network for object detection in an unprocessed image.

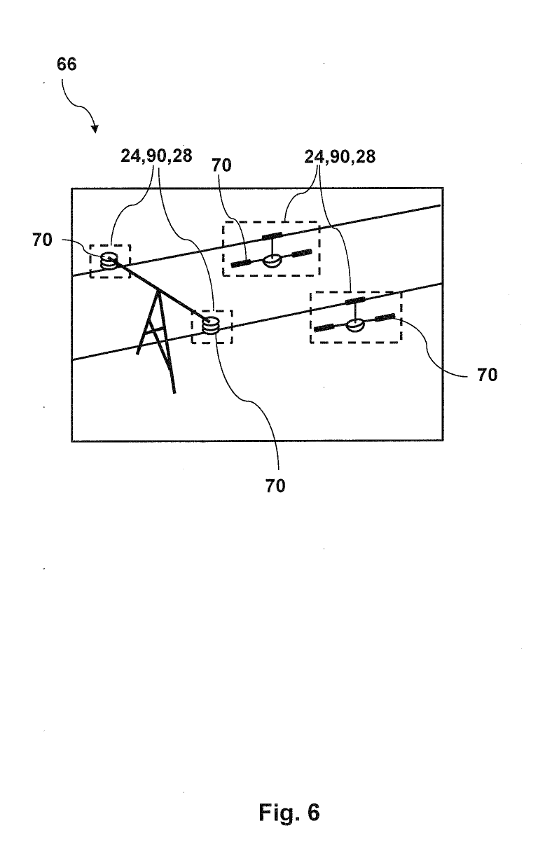

FIG. 6 shows an exemplary training image (66), on which different objects (70) are annotated (24) and associated with an object class (90). The objects (70) are annotated (24) using area-selection (28). The example on the training image concerns high voltage cable systems. The annotated objects are two vibration absorbers and two insulators. All four objects (70) are individually annotated (24) and associated with an object class (90). Other objects that can be relevant in other connections may, for example, be the cables or the mast, which should then have been annotated (24) as objects and associated with an object class (90).

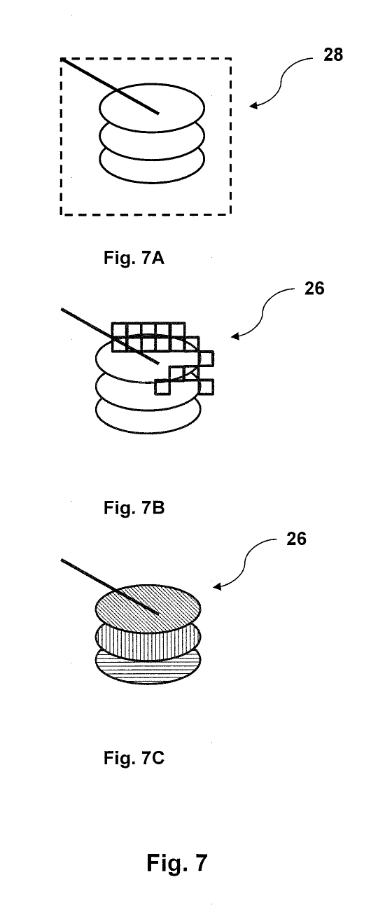

FIG. 7A and FIGS. 7B and 7C illustrate two different approaches for the annotation of objects, e.g., area-selection (28) and pixel-segmentation (26). For the illustrated diagrams of FIGS. 7A-7C, an insulator is used as the object for an exemplary purpose. The exemplary computer-implemented annotation tool provides for both kinds of annotation and may be used in both cases. It should be understood that other appropriate annotations tools may also be used.

For example, FIG. 7A shows an exemplary area-selection (28). Area-selection can be performed by framing the object, as illustrated by the broken line. An exemplary pixel-segmentation (26) is illustrated in FIGS. 7B and 7C. The exemplary pixel-segmentation (26) can be performed by, e.g., choosing the pixels constituting the imaged object or a small selection of the pixels constituting a small part of the imaged object. From the selected pixels the annotation tool locates the boundaries of the object. Thus, the object can be annotated by the located boundaries—as illustrated in FIG. 7C—by the patterned areas.

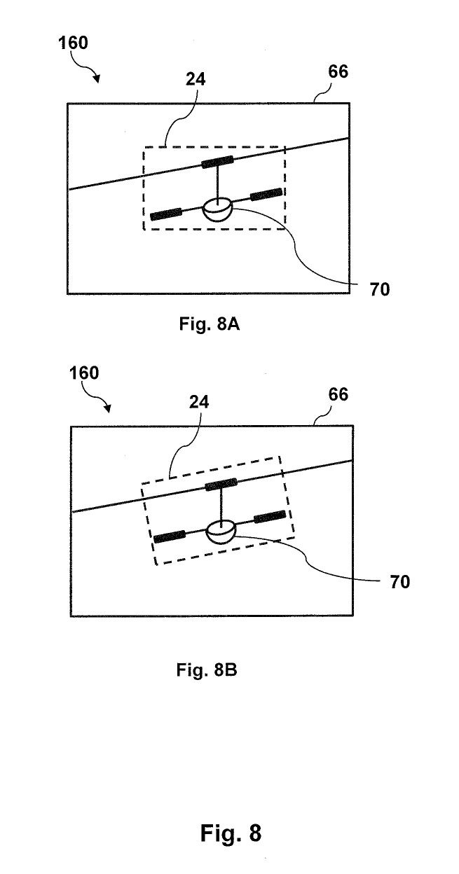

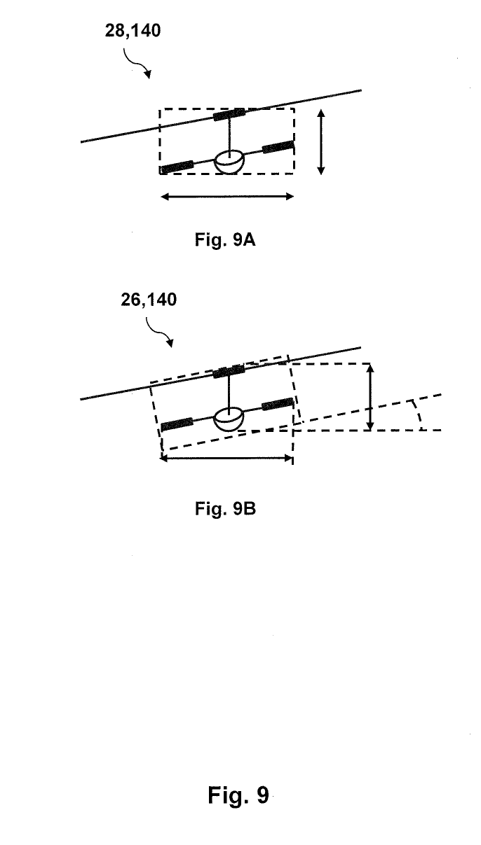

FIGS. 8A and 8B illustrate an annotation (24) using the computer-implemented annotation tool (160) according to an exemplary embodiment of the present disclosure. The annotation may subsequently be used for intelligent augmentation (140). As shown in FIG. 8A, an object (70) on the training image (66) is annotated (24) using area-selection. The exemplary object is a vibration absorber. In FIG. 8B, a rotated area-selection is used. The rotated area-selection may subsequently be used for intelligent augmentation, as illustrated in FIGS. 9A and 9B. The rotated annotation shown in FIG. 8B can facilitate a more accurate object classification.

FIGS. 9A and 9B illustrate a diagram of an intelligent data augmentation according to an exemplary embodiment of the present disclosure. In FIG. 9A, the object is annotated using area-selection, and in FIG. 9B, pixel-segmentation is used for annotating the object. In both cases, the intelligent augmentation (140) can be performed by extracting information of the dimensions and by rotation of the object. As shown in FIGS. 9A and 9B, width, length and rotation of the object can be extracted. Relating information of dimensions and rotation may be used for scaling the images for more accurate object detection. Furthermore, this information can be used when converting from pixel-segmentation to area-selected annotation or marking.

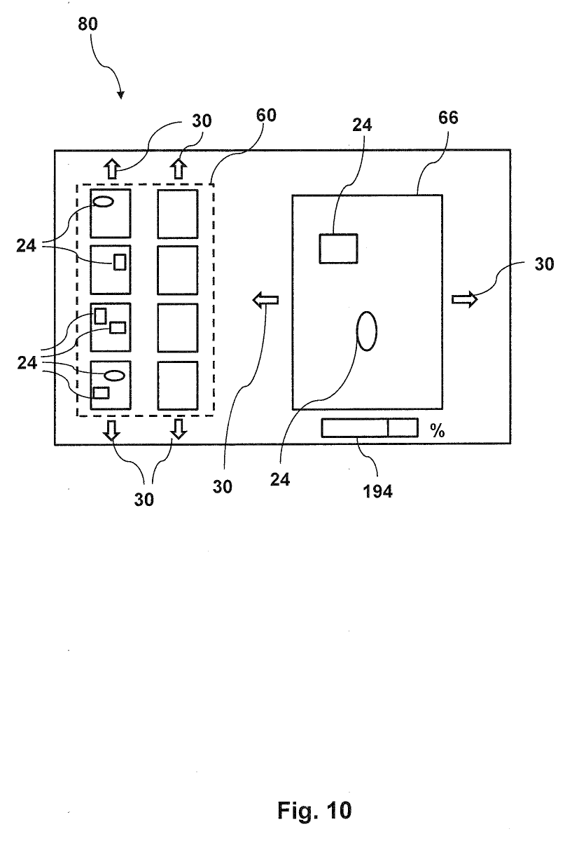

FIG. 10 shows a diagram of the computer-implemented navigation tool according to an exemplary embodiment of the present disclosure. The graphical navigation tool is displayed as GUI (80) in FIG. 10. The GUI (80) may be divided into several sections: One section, where the current training image (66) with annotations (24) is displayed and provided with forward and backward navigation (30) between the training images (66), another section, here illustrated below the training image (66), may display the status (194) on progression (196) of evaluating the image training batch. The status may display how many of the training images (66) of the image training batch annotation and object classification has been performed. The status may be displayed in percentage, as the current image number vs total amount of images, or in other appropriate measures. Yet another section may display two rows of images comprising the image training batch (60), where one row shows previous training images on which, annotation (24) and classification have been performed, thus this row shows the annotation history. The other row may show the subsequent training images, which has not yet been subject to annotation (24) and object classification. Both rows may be provided with forward and backward navigation (30) between the training images (66). Each row can be displayed alone or together.

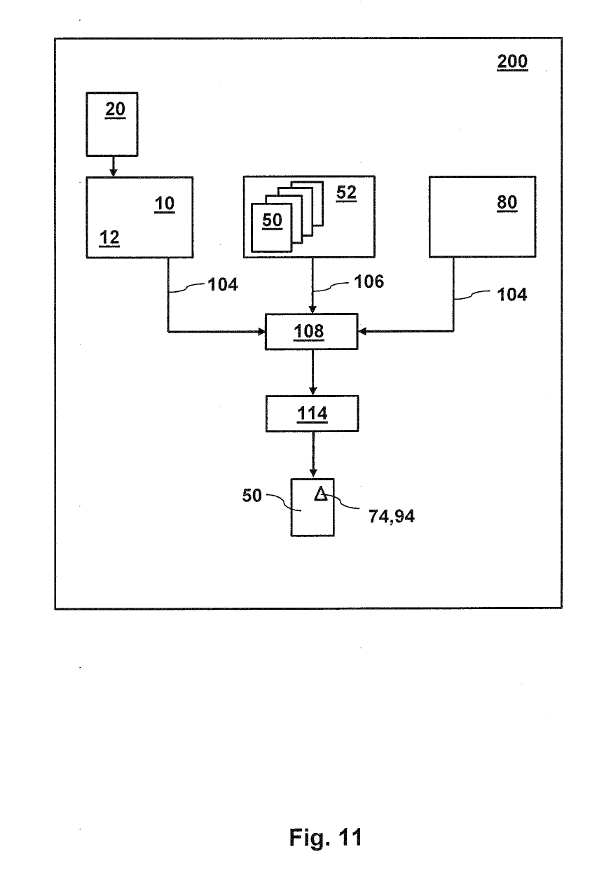

FIG. 11 illustrates the computer-implemented method (200) in a neural network (10) for object detection in an unprocessed image (50) with probability of object detection according to an exemplary embodiment of the present disclosure. This exemplary method can comprises the acts/procedures of providing (104) a neural network (10) configured with a set of specifications (12) and a graphical user interface (GUI) (80). Furthermore, an act/procedure of establishing (106) at least one unprocessed image batch (52) can be included in this exemplary method.

The unprocessed image batch (52) may comprise at least one unprocessed image (50) to be subject for object detection. The neural network (10) can be provided with a constructed model (20) with trained collective model variables and the GUI (80) is configured for displaying one or more unprocessed images (50) with a set of marked objects (74) and associated object classes (90).

Further, the exemplary method can comprise the further acts/procedures of performing (108) object detection in an unprocessed image and returning (114) the unprocessed image (50) with a set of marked objects (74) and machine classified objects (94).

1-15. (canceled)

16. A computer-implemented method for constructing a model in a neural network for object detection in an unprocessed image, the construction of the model being performed based on at least one image training batch, and the neural network configured with a set of specifications, the method comprising:
establishing at least one image training batch which comprises at least one training image that includes one or more objects, wherein an individual object of the objects is a member of an object class;
with a graphical user interface (GUI), displaying a training image from the image training batch; and
iteratively performing:
a) annotating the one or more objects in the training image via a user interaction so as to generate individually annotated one of more objects,
b) associating an annotation with the object class for the annotated one or more objects in the training image via the user interaction,
c) returning a user annotated image training dataset comprising the at least one training image with the annotated one or more objects, each individual one of the one or more annotated objects being associated with the object class; _{[NS-PA1]}and
d) generating the model by training one or more collective model variables in the neural network to classify the individual annotated one or more objects as a member of the object class,
wherein, the model, together with the set of specifications when implemented in the neural network, is configured to effectuate the object detection in the unprocessed image with a particular probability of the object detection.

17. The computer-implemented method according to claim 16, further comprising iteratively performing:
e) displaying the training image comprising one or more machine marked objects associated with a machine performed classification of the one or more individual objects, modifying at least one of a machine object marking or a machine object classification, and
f) evaluating a level of the training of the collective model variables for terminating the training of the model.

18. The computer-implemented method according to claim 16, wherein the substeps (a)-(c) are performed iteratively before subsequently performing the substep (d).

19. The computer-implemented method according to claim 16, further comprising a performing an intelligent augmentation which includes processing the annotated objects in the training image, and providing each resulting augmented one of the annotated objects a weighting for a particular probability of an occurrence.

20. The computer-implemented method according to claim 16, further comprising a establishing at least one image verification batch for testing the generated model with a subsequent generated model that is generated after a subsequent training by comparing the particular probability of the object detection reached with the generated models.

21. The computer-implemented method according to claim 16, further comprising a utilizing an accuracy by which the object detection is performed for at least one of (i) evaluating the generated model or a use of the neural network specifications, and for evaluating a use of a simpler model or a simpler neural network for reducing a complexity of the model, or (ii) reducing the specifications.

22. The computer-implemented method according to claim 16, further comprising utilizing an accuracy by which the object detection is performed for evaluating an accuracy of the object detection of the generated model, and for evaluating a use of a reduced image training batch.

23. The computer-implemented method according to claim 16, wherein the annotating of the one or more objects is performed by an area-selection of the training image comprising an object-segmentation or a pixel-segmentation of the one or more objects.

24. The computer-implemented method according to claim 16, wherein the annotating of the one or more objects is performed with a computer-implemented annotation tool configured with a zoom-function so as to at least one of:
provide an area-selection interface for an adjustable area-selection of the one or more objects in the training image via the user interaction, or
provide a pixel-segmentation interface for a pixel-segmentation of the one or more objects in the training image via the user interaction, wherein the pixel-segmentation is configured to pre-segment pixels by grouping the pixels similar to a small selection of the pixels chosen via the user interaction,
wherein the annotation tool is configured to transform the annotation from the pixel-segmentation of the one or more objects into the area-selection of the one or more objects in the training image.

25. The computer-implemented method according to claim 24, wherein the computer-implemented annotation tool facilitates at least one of:
a color-overlay annotation, wherein a color is associated with an object classification that is associated with the annotation, or
a re-classification of at least one of the one or more individual annotated objects (72) or machine marked objects,
wherein the annotation tool is configured to show all annotations and machine marks associated with an object class in the at least one training image.

26. The computer-implemented method according to claim 24, wherein the computer-implemented annotation tool further provides a history of the performed annotation.

27. The computer-implemented method according to claim 16, wherein navigation in the image training batch is performed using a computer-implemented navigation tool which facilitates:
a navigation by an image management procedure, and
a status on a progression of evaluating the image training batch.

28. The computer-implemented method according to claim 16, wherein the at least one image training batch is collected using an airborne vehicle.

29. A computer-implemented method provided in a neural network for an object detection in an unprocessed image having a particular probability of the object detection, the method comprising:
providing a generated model, the generation of the model being performed based on at least one image training batch, and the neural network configured with a set of specifications, comprising:
establishing at least one image training batch which comprises at least one training image that includes one or more objects, wherein an individual object of the objects is a member of an object class;
with a graphical user interface (GUI), displaying a training image from the image training batch; and
iteratively performing:
a) annotating the one or more objects in the training image via a user interaction so as to generate individually annotated one of more objects,
b) associating an annotation with the object class for the annotated one or more objects in the training image via the user interaction,
c) returning a user annotated image training dataset comprising the at least one training image with the annotated one or more objects, each individual one of the annotated one or more annotated objects associated with the object class, and
d) generating the model by training one or more collective model variables in the neural network to classify the individual annotated one or more objects as a member of the object class,
wherein, the model, together with the set of specifications when implemented in the neural network, is configured to effectuate the object detection in the unprocessed image with a particular probability of the object detection;
establishing at least one unprocessed image batch that comprises at least one unprocessed image to be subject for the object detection;
with the GUI, displaying one or more unprocessed images with a set of marked objects, each one of the marked objects being associated with the object class;
performing the object detection in an unprocessed image; and
returning the unprocessed image with the set of marked objects, each of the marked objects being associated with the object class.

30. The computer-implemented method according to claim 29, further comprising a providing access to the neural network for further training of one or more collective model variables of the model, such that the model is subject to an improved accuracy of the object detection.

31. The computer-implemented method according to claim 29, wherein the unprocessed image is collected using an airborne vehicle.
